(19) United States
(12) Patent Application Publication
(10) Pub. No.: US 2006/0007840 A1
(43) Pub. Date: Jan. 12, 2006

(54) Objective lens and optical head device provided with the same

(76) Inventors: Kenichi Hayashi, Nagano (JP); Tetsuro Okamura, Nagano (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/177,099

(22) Filed: Jul. 8, 2005

(30) Foreign Application Priority Data
Jul. 9, 2004 (JP) 2004-203431

(51) Int. Cl. G11B 7/00

(52) U.S. Cl. 369/112.23; 369/44.23

(57) ABSTRACT

An objective lens by which an effective value of spherical aberration with respect to an optical recording medium is reduced and in which a beam spot having a small diameter can be formed on a recording surface of the optical recording medium. An objective lens for an optical head device comprises a refraction surface provided with a middle region and a peripheral region, where, assuming that a distance from an optical axis to an outer peripheral portion of the middle region in a direction crossing the optical axis at right angles is R, there exist in a range of R/3 to 2R/3 from the optical axis, zero regions where the spherical aberration with respect to an optical recording medium turns to zero and/or an increase/decrease region where the spherical aberration with respect to the optical recording medium increases or decreases toward zero.

### CROSS-REFERENCE TO RELATED APPLICATIONS

This application claims priority to Japanese Application No. 2004-203431 filed Jul. 9, 2004, which is incorporated herein by reference.

### FIELD OF THE INVENTION

The present invention relates to an objective lens for use in an optical head device for recording and reproducing data with respect to optical recording mediums such as a CD and a DVD having different thicknesses of transparent substrates, using laser light having different wavelengths. The present invention also relates to an optical head device provided with the objective lens.

### BACKGROUND OF THE INVENTION

An optical head device that records and reproduces data with respect to optical recording mediums having different thicknesses of transparent substrates for protecting recording surfaces, and different recording densities, using laser light having different wavelengths has been known in the art. Examples of the optical recording medium include a CD, a DVD and the like. Here, in the CD, the thickness of the transparent substrate which protects the recording surface is 1.2 mm. In the DVD, the thickness of the transparent substrate is 0.6 mm, which is smaller than that of the CD, and a recording density is higher than that of the CD. Therefore, for example, the laser light having a wavelength of 790 nm is used in the recording/reproducing with respect to the CD, whereas laser light having a wavelength of 660 mm is used in the recording/reproducing with respect to the DVD.

In this type of optical head device, in order to achieve miniaturization and thickness reduction of the device, a certain constitution has been proposed in which laser light having a wavelength adapted to each optical recording medium is condensed on the recording surface of the optical recording medium using a single optical condensing system (see, e.g., Japanese Patent Application Laid-Open No. 2000-81566).

In the optical head device described in Japanese Patent Application Laid-Open No. 2000-81566, an objective lens is used in which diffraction grating is formed in a refraction surface. In this optical head device, diffracted laser light having a short wavelength is condensed on the recording surface of the DVD, and the diffracted laser light having a long wavelength is condensed on the recording surface of the CD. However, since unnecessary diffracted light is generated in the objective lens including the diffraction grating formed in the refraction surface, there is a problem of a loss of quantity of light, indicating a drop of transmittance of the laser light.

Therefore, a certain optical head device has been proposed in which the problem of the loss of quantity of light is solved while using the single optical condensing system (e.g., Japanese Patent Application Laid-Open No. 10-55564)

In the optical head device described in Japanese Patent Application Laid-Open No. 10-55564, an objective lens is used which has a middle region centering on an optical axis and a peripheral region concentrically formed on an outer peripheral side of the middle region. In the refraction surface of the objective lens, the middle region and the peripheral region are formed into one aspherical shape, and there is a boundary between the middle region and the peripheral region in a position whose numerical aperture substantially agrees with a numerical aperture NA1 required in the recording/reproducing with respect to the CD.

In the optical head device described in Japanese Patent Application Laid-Open No. 10-55564, the middle region of the objective lens is formed into one aspherical shape. Therefore, for example, as shown in FIG. 8A, a spherical aberration with respect to the DVD has a distribution in which the spherical aberration rapidly and discontinuously changes from a so-called insufficiently corrected state (under) to an excessively corrected state (over) in an outer peripheral portion (boundary between the middle region and the peripheral region, NA1) of the middle region. Alternatively, in the distribution, as shown in FIG. 8B, excessive correction (over) is seen in the vicinity of a middle between the optical axis and the outer peripheral portion of the middle region in a direction crossing the optical axis at right angles. It is to be noted that NA2 in FIG. 8 denotes a numerical aperture required in the recording/reproducing with respect to the DVD.

For example, since the recording density of the DVD is higher than that of the CD as described above, a beam spot having a small diameter needs to be formed on the recording surface of the DVD. An effective value of the spherical aberration needs to be reduced in order to form the beam spot having the small diameter. For example, in the optical head device described in Japanese Patent Application Laid-Open No. 10-55564, it is preferable to use the objective lens having the spherical aberration distribution shown in FIG. 8B rather than the spherical aberration distribution shown in FIG. 8A. It is to be noted that as far as FIG. 8 is referred to, it seems that the effective value of the spherical aberration can be reduced in the spherical aberration distribution shown in FIG. 8A. However, in actuality, FIG. 8A is different from FIG. 8B in display scale, and the spherical aberration shown in FIG. 8A has very large values as compared with that shown in FIG. 8B.

However, in the spherical aberration distribution shown in FIG. 8B, there exists a region where the spherical aberration increases in a plus (over) direction in the vicinity of the middle between the optical axis and the outer peripheral portion of the middle region in the direction crossing the optical axis at right angles, and the effective value of the spherical aberration cannot be sufficiently reduced. This is an obstruction in forming the beam spot having a small diameter on the recording surface of the DVD.

### SUMMARY OF THE INVENTION

An object of the present invention is to provide an objective lens by which an effective value of spherical aberration with respect to an optical recording medium is reduced, so that a beam spot having a small diameter can be formed on the recording surface of the optical recording medium. Another object is to provide an optical head device provided with the objective lens.

To solve the above-described problem, according to the present invention, there is provided an objective lens for an optical head device which condenses two or more laser beams having wavelengths adapted to two or more optical recording mediums having different thicknesses of transparent substrates on recording surfaces of the optical recording mediums via one optical condensing system to record information on the recording surfaces and/or reproduce the information on the recording surfaces, the objective lens comprising a refraction surface including: a middle region which is formed in a middle portion of the refraction surface centering on an optical axis of the objective lens and which is used with respect to all of the optical recording mediums; and a peripheral region which is concentrically formed adjacent to an outer peripheral side of the middle region, wherein assuming that a distance from the optical axis to an outer peripheral portion of the middle region in a direction crossing the optical axis at right angles is R, there exist, in a range of R/3 to 2R/3 from the optical axis, a zero region where spherical aberration with respect to at least one of the optical recording mediums is zero and/or an increase/decrease region where the spherical aberration with respect to at least one of the optical recording mediums increases or decreases toward zero.

In the present invention, in the range of R/3 to 2R/3 from the optical axis, in which the spherical aberration has heretofore increased, there exist the zero region where the spherical aberration with respect to at least one optical recording medium is zero and/or the increase/decrease region where the spherical aberration with respect to at least one of the optical recording mediums increases or decreases toward zero. Therefore, it is possible to sufficiently reduce the spherical aberration with respect to at least one optical recording medium. Since the effective value of the spherical aberration can be sufficiently reduced, it is also possible to reduce a wave front aberration with respect to at least one optical recording medium.

Here, in the present specification, the zero region means a region where the spherical aberration with respect to one optical recording medium turns from plus (over) to minus (under) or from minus to plus. The increase/decrease region is a region, in which the spherical aberration with respect to one optical recording medium does not turn to zero, but increases or decreases toward zero and which includes a minimum value or a maximum value.

In the present invention, the middle region comprises a plurality of annular refraction surfaces having aspherical shapes which are mutually different in refractive force, and stepped portions are preferably formed toward an optical axis direction in boundaries among the plurality of annular refraction surfaces. By this constitution, the zero region or the increase/decrease region can exist by a simple constitution in the vicinity of a middle between the optical axis and the outer peripheral portion of the middle region in the direction crossing the optical axis at right angles, in which the spherical aberration has heretofore increased because the middle region is formed into one aspherical shape. Therefore, the effective value of the spherical aberration can be sufficiently reduced.

In the present invention, for example, the optical recording mediums include a first optical recording medium on which a first laser beam having a first wavelength is condensed, and a second optical recording medium on which a second laser beam having a second wavelength shorter than the first wavelength is condensed, and the zero region and/or the increase/decrease region exist with respect to the second optical recording medium. In this case, it is possible to reduce the effective value of the spherical aberration with respect to the second optical recording medium on which a beam spot having a smaller diameter needs to be formed, and the small beam spot can be formed on the recording surface of the second optical recording medium.

Moreover, in the present invention, the optical recording mediums include a first optical recording medium on which a first laser beam having a first wavelength is condensed, and a second optical recording medium on which a second laser beam having a second wavelength shorter than the first wavelength is condensed, and the zero region and/or the increase/decrease region may exist with respect to the first optical recording medium. In this case, it is possible to reduce the effective value of the spherical aberration with respect to the first optical recording medium, and the small beam spot can be formed on the recording surface of the first optical recording medium. As a result, a recording/reproducing performance of the first optical recording medium can be enhanced.

Furthermore, according to the present invention, there is provided an objective lens for an optical head device which condenses two or more laser beams having wavelengths adapted to two or more optical recording mediums having different thicknesses of transparent substrates on recording surfaces of the optical recording mediums via one optical condensing system to record information on the recording surfaces and/or reproduce the information on the recording surfaces, the objective lens comprising a refraction surface including: a middle region which is formed in a middle portion of the refraction surface centering on an optical axis of the objective lens and which is used with respect to all of the optical recording mediums; and a peripheral region which is concentrically formed adjacent to an outer peripheral side of the middle region, wherein an optimum region where spherical aberration with respect to one optical recording medium is corrected to be optimum exists in at least one position in a range from the optical axis to an outer peripheral portion of the middle region in a direction crossing the optical axis at right angles.

In the present invention, there exists the optimum region where the spherical aberration with respect to one optical recording medium continues to indicate zero. In this case, a limited region, corresponding to this optimum region, sometimes exists in which any laser light is not condensed on the recording surface in the spherical aberration distribution with respect to another optical recording medium. However, when there is an extra power of the laser light with respect to the other optical recording medium, a recording/reproducing performance of the other optical recording medium is not much influenced even in the existence of the limited region with respect to the other optical recording medium, and the recording/reproducing performance of one optical recording medium can be effectively enhanced. That is, since any light is not condensed in the limited region, use efficiency (transmittance) of the light drops with respect to the other optical recording medium. However, when there is an extra power of the laser light, the recording/reproducing performance is not much influenced even with the drop of the use efficiency of the light to a certain degree. Here, the one optical recording medium is, for example, a CD, a DVD, or a blue ray disc (BD).

In the present invention, assuming that a distance from the optical axis to the outer peripheral portion of the middle region in the direction crossing the optical axis at right angles is R, the optimum region preferably exists in a range of R/3 to 2R/3 from the optical axis. In this case, even when the use efficiency (transmittance) of the light with respect to the other optical recording medium is sacrificed to a certain degree, the effective value of the spherical aberration with respect to the one optical recording medium is further reduced, and the beam spot having a smaller diameter can be formed by the existence of the optimum region with respect to the one optical recording medium in the vicinity of the middle between the optical axis and the outer peripheral portion of the middle region in a direction crossing the optical axis at right angles, in which the spherical aberration has heretofore increased. As a result, the recording/reproducing performance of the one optical recording medium can be more effectively enhanced. It is possible to form the beam spot having the smaller diameter, via which the light passed through the region having the large spherical aberration is not condensed even with respect to the other optical recording mediums.

The objective lens of the present invention can be used in an optical head device comprising: an optical condensing system having the objective lens; and a laser light source which emits the laser beam, wherein information is recorded on the recording surface and/or information on the recording surface is reproduced.

When the objective lens of the present invention is used as described above, there exist a zero region where spherical aberration with respect to at least one optical recording medium is zero and/or an increase/decrease region where spherical aberration with respect to at least one optical recording medium increases or decreases toward zero in a range of R/3 to 2R/3 from an optical axis, in which the spherical aberration has heretofore increased. Therefore, an effective value of the spherical aberration with respect to at least one optical recording medium can be sufficiently reduced, and a wave front aberration can also be reduced. Therefore, it is possible to form a beam spot having a smaller diameter on the recording surface of at least one optical recording medium. As a result, a recording/reproducing performance can be enhanced.

### BRIEF DESCRIPTION OF THE DRAWINGS

FIG. 1 is a schematic diagram showing a constitution of an optical head device according to an embodiment of the present invention;

FIG. 2 is a sectional view schematically showing an objective lens of the optical head device shown in FIG. 1;

FIG. 3 is a graph showing one example of a spherical aberration distribution at a time when the objective lens shown in FIG. 2 is used, both FIG. 3A and FIG. 3B are graphs showing the spherical aberration distribution with respect to a second optical recording medium in the embodiment, and FIG. 3C is a graph showing the spherical aberration distribution with respect to a second optical recording medium in a comparative mode;

FIG. 4 is a graph showing another example of the spherical aberration distribution at the time when the objective lens shown in FIG. 2 is used, and FIG. 4A and FIG. 4B are graphs showing the spherical aberration distributions with respect to a first optical recording medium in the embodiment and that in the comparative mode, respectively;

FIG. 5 is a graph showing another example of the spherical aberration distribution at the time when the objective lens shown in FIG. 2 is used, and FIG. 5A and FIG. 5B are graphs showing the spherical aberration distributions with respect to the second optical recording medium in the embodiment and the first optical recording medium in the embodiment, respectively;

FIG. 6 is a graph showing another example of the spherical aberration distribution at the time when the objective lens shown in FIG. 2 is used, and FIG. 6A and FIG. 6B are graphs showing the spherical aberration distributions with respect to the second optical recording medium in the embodiment and the first optical recording medium in the embodiment, respectively;

FIG. 7 shows the spherical aberration distribution at the time when the objective lens of the embodiment is used, and FIG. 7A and FIG. 7B are graphs showing the spherical aberration distributions with respect to a DVD and a CD, respectively; and

FIGS. 8A and 8B are graphs showing a spherical aberration distribution at a time when an objective lens of a conventional technique is used.

### DETAILED DESCRIPTION OF THE PREFERRED EMBODIMENTS

An embodiment of the present invention will be described hereinafter with reference to the drawings.

Schematic Constitution of Optical Head Device

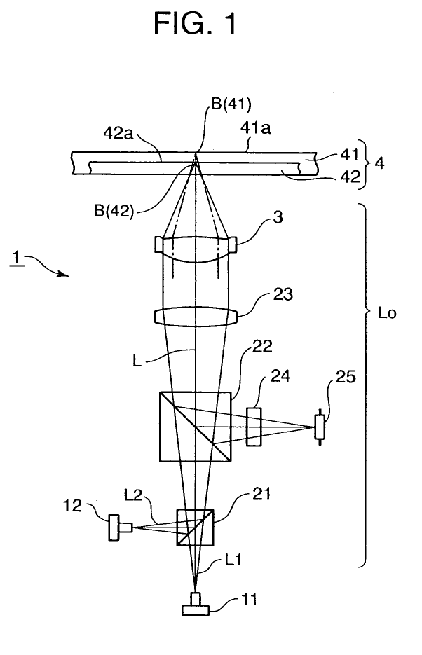

FIG. 1 is a schematic diagram showing a constitution of an optical head device according to an embodiment of the present invention.

In FIG. 1, an optical head device 1 condenses a plurality of laser beams having wavelengths adapted to a plurality of types of optical recording mediums 4 having different thicknesses of transparent substrates or recording densities, such as a CD and a DVD, on recording surfaces of the optical recording mediums 4 via one optical condensing system Lo to reproduce or record information with respect to the optical recording mediums 4. The optical recording mediums 4 in the present embodiment include a CD 41 which is a first optical recording medium, and a DVD 42 which is a second optical recording medium. The optical head device 1 includes: a first laser light source 11 for emitting a first laser beam L1, for example, having a first wavelength of 790 nm for use in reproducing the information from the CD 41; and a second laser light source 12 for emitting a second laser beam L2, for example, having a second wavelength of 660 nm for use in reproducing the information from the DVD 42. The respective laser beams L1, L2 are guided into the optical recording mediums 4 via the common optical condensing system Lo, and return beams of the respective laser beams L1, L2 reflected by the optical recording mediums 4 are guided into a common light receiving element 25.

The optical condensing system Lo includes: a first beam splitter 21 which allows the first laser beam L1 to propagate rectilinearly and which reflects the second laser beam L2 to align both of the beams with a system optical axis L (optical axis of an objective lens, hereinafter referred to as the optical axis L); a second beam splitter 22 which passes the laser beams L1, L2 traveling along the optical axis L; a collimating lens 23 for converting the laser beams L1, L2 passed through the second beam splitter 22 into parallel beams; and an objective lens 3 for forming beam spots of the laser beams L1, L2 emitted from the collimating lens 23 on recording surfaces of the optical recording mediums 4. In the present embodiment, as to a recording surface 42a of the DVD 42 which is one of the optical recording mediums 4, and a recording surface 41a of the CD 41, the beam spot of the first laser beam L1 is formed on the recording surface 41a of the CD 41, and the beam spot of the second laser beam L2 is formed on the recording surface 42a of the DVD 42 by the objective lens 3.

Moreover, the optical condensing system Lo includes a grating 24 for guiding into the common light receiving element 25 the return beams of the first and second laser beams L1, L2 reflected by the optical recording mediums 4 and then the second beam splitter 22.

To record/reproduce the information with respect to the CD 41 which is the optical recording medium 4 in the optical head device 1 constituted in this manner, the first laser light source 11 emits the first laser beam L1 having a wavelength of 790 nm. The first laser beam L1 is guided into the optical condensing system Lo to form a beam spot B (41) on the recording surface 41a of the CD 41 via the objective lens 3. The return beam of the first laser beam L1 reflected by the recording surface 41a of the CD 41 is condensed onto the common light receiving element 25 via the second beam splitter 22. The information of the CD 41 is reproduced by a signal detected by the common light receiving element 25.

On the other hand, to reproduce the information of the DVD 42 which is the optical recording medium 4, the second laser light source 12 emits the second laser beam L2 having a wavelength of 660 nm. The second laser beam L2 is also guided into the optical condensing system Lo to form a beam spot B (42) on the recording surface 42a of the DVD 42 via the objective lens 3. The return beam of the second laser beam L2 reflected by the recording surface 42a of the DVD 42 is condensed onto the common light receiving element 25 via the second beam splitter 22. The information of the DVD 42 is reproduced by a signal detected by the common light receiving element 25.

Constitution of Objective Lens

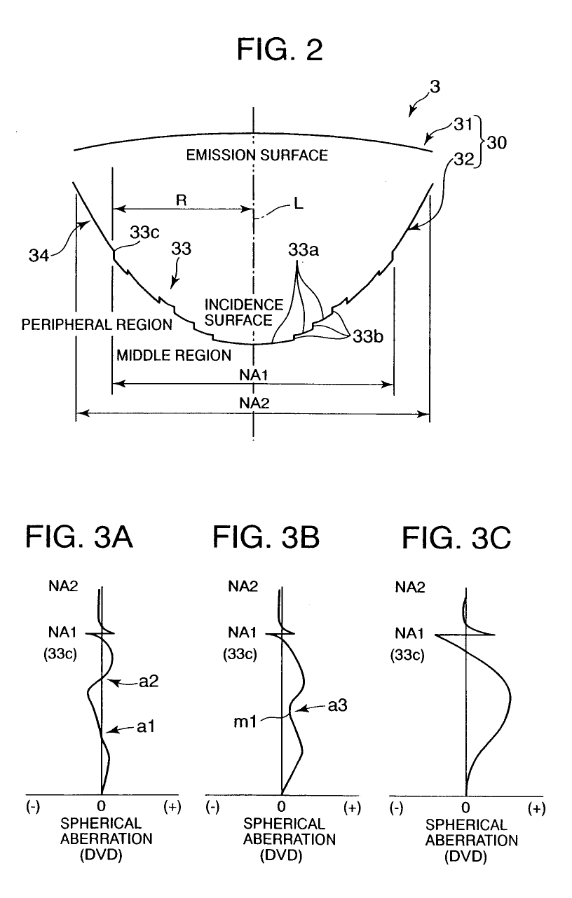

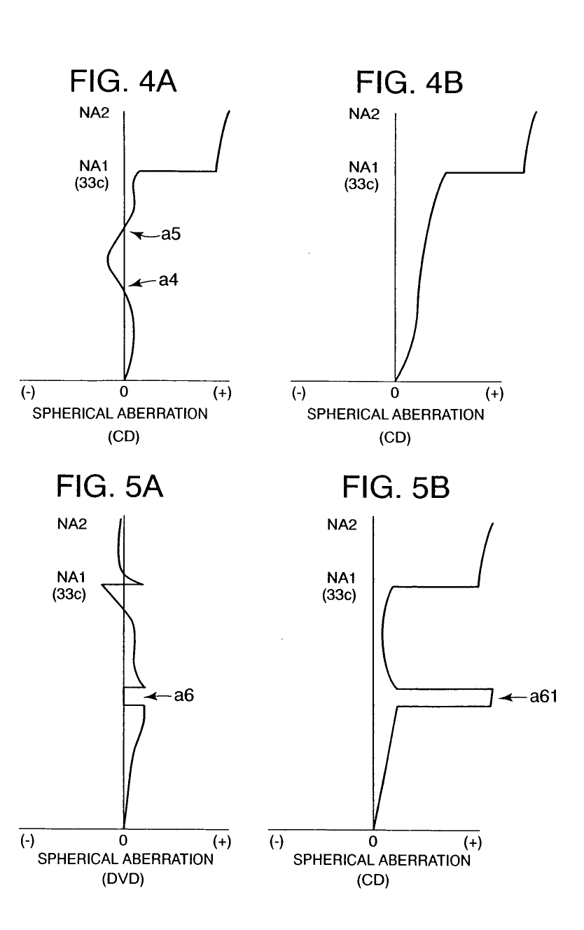

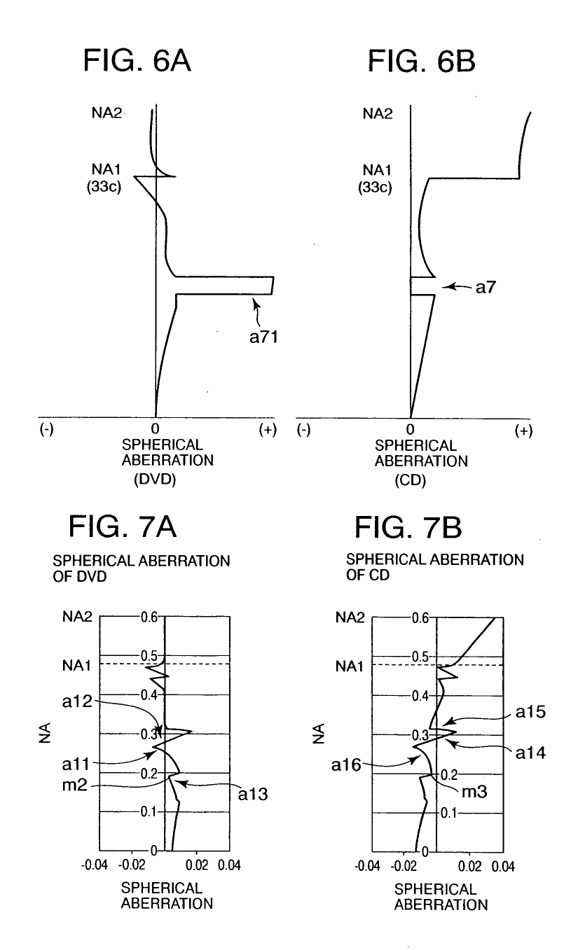

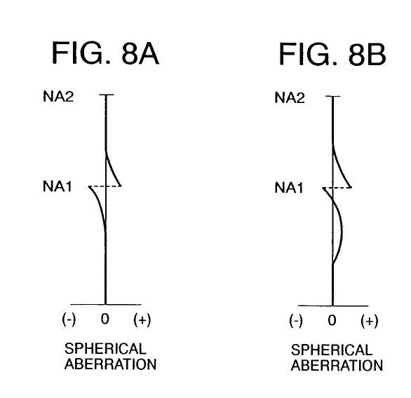

FIG. 2 is a sectional view schematically showing an objective lens of the optical head device shown in FIG. 1. FIG. 3 is a graph showing one example of a spherical aberration distribution at a time when the objective lens shown in FIG. 2 is used. Both FIG. 3A and FIG. 3B are graphs showing the spherical aberration distribution with respect to the second optical recording medium in the embodiment, and FIG. 3C is a graph showing the spherical aberration distribution with respect to the second optical recording medium in a comparative mode. FIG. 4 is a graph showing another example of the spherical aberration distribution at the time when the objective lens shown in FIG. 2 is used. FIG. 4A and FIG. 4B are graphs showing the spherical aberration distributions with respect to the first optical recording medium in the embodiment and that in the comparative mode, respectively. FIG. 5 is a graph showing another example of the spherical aberration distribution at the time when the objective lens shown in FIG. 2 is used. FIG. 5A and FIG. 5B are graphs showing the spherical aberration distributions with respect to the second optical recording medium in the embodiment and the first optical recording medium in the embodiment, respectively. FIG. 6 is a graph showing another example of the spherical aberration distribution at the time when the objective lens shown in FIG. 2 is used. FIG. 6A and FIG. 6B are graphs showing the spherical aberration distributions with respect to the second optical recording medium in the embodiment and the first optical recording medium in the embodiment, respectively.

As shown in FIG. 2, the objective lens 3 is a convex lens whose opposite surfaces are formed into convex shapes. On the objective lens 3, a refraction surface 30 is formed, and the refraction surface includes: an emission surface 31 formed into a single aspherical shape on an optical recording medium 4 side; and an incidence surface 32 formed on the side of the laser light sources 11, 12. The incidence surface 32 includes: a middle region 33 formed in a middle portion of the incidence surface 32 centering on the optical axis L; and a peripheral region 34 concentrically formed adjacent to an outer peripheral side of the middle region 33. The middle region 33 is used with respect to the CD 41 and the DVD 42, and the peripheral region 34 is used only with respect to the DVD 42.

The middle region 33 has a plurality of annular refraction surfaces 33a (hereinafter referred to as the annular refraction surfaces 33a) which are mutually different in refractive force and which have aspherical shapes. Moreover, stepped portions 33b (hereinafter referred to as the stepped portions 33b) are formed toward an optical axis L direction in boundaries among the plurality of annular refraction surfaces 33a. A numerical aperture of an outer peripheral portion 33c of the middle region 33 substantially agrees with a numerical aperture NA1 required in recording/reproducing the information with respect to the CD 41. It is to be noted that in FIG. 2, only some of the annular refraction surfaces and the stepped portions are denoted with reference numerals.

In the present configuration, the peripheral region 34 is formed into one aspherical shape, and this aspherical shape is such an aspherical surface that corrects the spherical aberration with respect to the DVD 42 to be optimum. It is to be noted that in the present embodiment, as shown in FIG. 2, the numerical aperture of the outer peripheral portion of the peripheral region 34 substantially agrees with a numerical aperture NA2 required in recording/reproducing the information with respect to the DVD 42.

Radial-direction positions (positions in a direction crossing the optical axis L at right angles) and heights of the stepped portions 33b formed in the middle region 33 are set, and the aspherical shapes of the annular refraction surfaces 33a are also set in such a manner as to satisfy predetermined conditions. Specifically, assuming that a distance from the optical axis L to the outer peripheral portion 33c of the middle region 33 in the direction crossing the optical axis L at right angles is R, there exist, in a range of R/3 to 2R/3 from the optical axis L, a zero region where spherical aberration with respect to at least one of the CD 41 and the DVD 42 is zero and/or an increase/decrease region where the spherical aberration with respect to at least one of the CD 41 and the DVD 42 increases or decreases toward zero. Alternatively, the radial direction positions and the heights of the stepped portions 33b, and the aspherical shapes of the annular refraction surfaces 33a are set in such a manner that there exists in at least one position an optimum region where the spherical aberration with respect to either of the CD 41 and the DVD 42 is corrected to be optimum.

For example, as shown in FIG. 3A, the radial direction positions and the heights of the stepped portions 33b, and the aspherical shapes of the annular refraction surfaces 33a (hereinafter referred to as “the shapes of the stepped portions 33b and the like”) are set in such a manner that zero regions a1 and a2 exist where the spherical aberration with respect to the DVD 42 is zero in the range of R/3 to 2R/3 from the optical axis L. In this case, the zero region a1 is a region where the spherical aberration with respect to the DVD 42 turns from plus (over) to minus (under), and the zero region a2 is a region where the spherical aberration with respect to the DVD 42 turns from minus to plus.

Alternatively, as shown in FIG. 3B, the shapes of the stepped portions 33b and the like are set in such a manner that there exists in the range of R/3 to 2R/3 from the optical axis L an increase/decrease region a3 where the spherical aberration with respect to the DVD 42 increases or decreases toward zero. In this case, in the increase/decrease region a3, the spherical aberration does not reach zero, but increases or decreases toward zero, and the region includes a minimum value m1. It is to be noted that the shapes of the stepped portions 33b and the like may be set in such a manner that both of the zero region and the increase/decrease region exist in the range of R/3 to 2R/3 from the optical axis L.

Thus, the shapes of the stepped portions 33b and the like are set in such a manner that there exist in the range of R/3 to 2R/3 from the optical axis L the zero region where the spherical aberration with respect to the DVD 42 turns to zero and/or the increase/decrease region where the spherical aberration with respect to the DVD 42 increases or decreases toward zero. In this case, it is seen that an effective value of the spherical aberration with respect to the DVD 42 is reduced as compared with the use of an objective lens in a comparative mode having a region where, as shown in FIG. 3C, the spherical aberration increases in the vicinity of a middle between the optical axis L and the outer peripheral portion 33c in the same manner as in a conventional mode.

Moreover, for example, as shown in FIG. 4A, the shapes of the stepped portions 33b and the like are set in such a manner that there exist zero regions a4 and a5 where the spherical aberration with respect to the CD 41 turns to zero in the range of R/3 to 2R/3 from the optical axis L. It is to be noted that as described above, the shapes of the stepped portions 33b and the like may be set in such a manner that the increase/decrease region exists instead of the zero region, or both of the zero region and the increase/decrease region exist in the range of R/3 to 2R/3 from the optical axis L.

Thus, the shapes of the stepped portions 33b and the like are set in such a manner that there exist in the range of R/3 to 2R/3 from the optical axis L the zero region where the spherical aberration with respect to the CD 41 turns to zero and/or the increase/decrease region where the spherical aberration with respect to the CD 41 increases or decreases toward zero. In this case, it is seen that an effective value of the spherical aberration with respect to the CD 41 is reduced as compared with the use of an objective lens in a comparative mode in which a spherical aberration distribution is generated in the same manner as in a conventional mode as shown in FIG. 4B.

Alternatively, the shapes of the stepped portions 33b and the like are set in such a manner that there exists an optimum region a6 where the spherical aberration with respect to the DVD 42 is corrected to be optimum as shown in FIG. 5A. Specifically, the shapes of the stepped portions 33b and the like are set in such a manner that the optimum region a6 exists in the range of R/3 to 2R/3 from the optical axis L. Here, in the optimum region a6, the spherical aberration with respect to the DVD 42 continues to indicate 0. In FIG. 5A, the shapes of the stepped portions 33b and the like are set in such a manner that the optimum region a6 exists in one position, but the shapes of the stepped portions 33b and the like may be set in such a manner that a plurality of optimum regions exist or the optimum region exists together with the above-described zero region or the increase/decrease region.

It is to be noted that in this case, as shown in FIG. 5B, there appears a limited region a61, corresponding to the optimum region a6, where the first laser beam L1 is not condensed on the recording surface 41 a of the CD 41 on the spherical aberration distribution with respect to the CD 41.

Moreover, the shapes of the stepped portions 33b and the like are set in such a manner that there exists an optimum region a7 where the spherical aberration with respect to the CD 41 is corrected to be optimum as shown in FIG. 6B. Specifically, the shapes of the stepped portions 33b and the like are set in such a manner that the optimum region a7 exists in the range of R/3 to 2R/3 from the optical axis L. Also in this case, as described above, the shapes of the stepped portions 33b and the like may be set in such a manner that a plurality of optimum regions exist or the optimum region exists together with the above-described zero region or the increase/decrease region.

It is to be noted that in this case, as shown in FIG. 6A, there appears a limited region a71, corresponding to the optimum region a7, where the second laser beam L2 is not condensed on the recording surface 42a of the DVD 42 on the spherical aberration distribution with respect to the DVD 42.

The above-described middle region 33 of the incidence surface 32 is designed, for example, in the following procedure. First, the radial-direction positions and the heights of the stepped portions 33b and the aspherical shapes of the annular refraction surfaces 33a are set in such a manner that the zero region and/or the increase/decrease region exist with respect to at least one of the CD 41 and the DVD 42 in the range of R/3 to 2R/3 from the optical axis L. Thereafter, as to portions other than portions corresponding to the zero region and the increase/decrease region, the radial-direction positions and the heights of the stepped portions 33b and the aspherical shapes of the annular refraction surfaces 33a are set in such a manner as to correct the spherical aberrations with respect to both of the CD 41 and the DVD 42 with a good balance.

Alternatively, the radial-direction positions and the heights of the stepped portions 33b and the aspherical shapes of the annular refraction surfaces 33a are set in such a manner that the optimum region exists with respect to the CD 41 or the DVD 42 in a range from the optical axis L to the outer peripheral portion 33c of the middle region 33. Thereafter, as to a portion other than a portion corresponding to the optimum region, the radial-direction positions and the heights of the stepped portions 33b and the aspherical shapes of the annular refraction surfaces 33a are set in such a manner as to correct the spherical aberrations with respect to both of the CD 41 and the DVD 42 with the good balance.

Main Effect of the Present Embodiment

As described above, when the objective lens 3 of the present embodiment is used, there exist the zero regions a1 and a2 where the spherical aberration with respect to the DVD 42 is zero and/or the increase/decrease region a3 where the spherical aberration with respect to the DVD 42 increases or decreases toward zero in the range of R/3 to 2R/3 from the optical axis L in which the spherical aberration has heretofore increased. Therefore, as apparent from FIG. 3, the effective value of the spherical aberration with respect to the DVD 42 can be sufficiently reduced. Since the effective value of the spherical aberration can be sufficiently reduced, a wave front aberration with respect to the DVD 42 can also be reduced. That is, a small beam spot can be formed on the recording surface 42a of the DVD 42 on which the beam spot having a smaller diameter needs to be formed, and a recording/reproducing performance of the DVD 42 can be enhanced.

Moreover, when the objective lens 3 of the present embodiment is used, there exist the zero regions a4 and a5 where the spherical aberration with respect to the CD 41 turns to zero and/or the increase/decrease region in the range of R/3 to 2R/3 from the optical axis L. Therefore, for example, as apparent from FIG. 4, the effective value of the spherical aberration with respect to the CD 41 can be sufficiently reduced. As a result, the small beam can be formed on the recording surface 41a of the CD 41, and the recording/reproducing performance of the CD 41 can be enhanced.

In the present embodiment, the middle region 33 comprises a plurality of annular refraction surfaces 33a having aspherical shapes having mutually different refractive forces, and the stepped portions are formed toward the optical axis L direction in the boundaries among the plurality of annular refraction surfaces 33a. Moreover, the radial-direction positions and the heights of the stepped portions 33b and the aspherical shapes of the annular refraction surfaces 33a are set in such a manner as to satisfy the preferable conditions. Therefore, with a simple constitution, the zero region or the increase/decrease region can exist in the range of R/3 to 2R/3 from the optical axis L in which the spherical aberration has heretofore increased. As a result, it is possible to sufficiently reduce the effective value of the spherical aberration of the CD 41 or the DVD 42.

Moreover, in the present embodiment, the optimum region a6 or a7 exists where the spherical aberration with respect to the CD 41 or the DVD 42 is corrected to be optimum. See FIG. 5A and FIG. 6B. In this case, on the distribution of the spherical aberration with respect to the CD 41 or the DVD 42, there appears the limited region a61 or a71 (see FIG. 5B and FIG. 6A), corresponding to the optimum region a6 or a7, where the laser beam L1 or L2 is not condensed on the recording surface 41a or 42a of the CD 41 or the DVD 42. However, in a case where there is an extra power in the laser light with respect to the optical recording medium 4 where the limited region a61 or a71 appears, even when the optimum region exists with respect to one optical recording medium 4, the recording/reproducing performance of the other optical recording medium 4 can be enhanced, while the recording/reproducing performance of the one optical recording medium 4 can be effectively enhanced.

In the present embodiment, the optimum region a6 or a7 exists in the range of R/3 to 2R/3 from the optical axis L. That is, the optimum region a6, a7 exists in this range in which the spherical aberration has heretofore increased. Therefore, the effective value of the spherical aberration with respect to one optical recording medium 4 can be further reduced, and the beam spot having a smaller diameter can be formed.

Furthermore, in the present embodiment, since the optical head device 1 comprises the optical condensing system Lo having the objective lens 3, the recording/reproducing performance can be enhanced with respect to at least one of the CD 41 and the DVD 42.

Another Embodiment

The above-described embodiment is an example of a preferable embodiment of the present invention, but the present invention is not limited to this embodiment, and can be variously modified within the scope of the present invention.

For example, shapes of stepped portions 33b and the like may be set in such a manner that zero regions and/or increase/decrease regions exist with respect to a CD 41 and a DVD 42 in a range of R/3 to 2R/3 from an optical axis L. In this case, recording/reproducing performances of both of the CD 41 and the DVD 42 can be enhanced.

It is to be noted that FIGS. 3 and 4 are conceptual, and a distribution of spherical aberration is not limited to that described with reference to FIGS. 3 and 4. For example, plus and minus of the spherical aberration may be reversed in the spherical aberration distribution. FIGS. 5 and 6 are similarly conceptual, and the spherical aberration distribution is not limited to that described with reference to FIGS. 5 and 6.

Moreover, the optical recording mediums 4 are not limited to the CD 41 and the DVD 42, and an objective lens 3 may be used with respect to a BD. That is, the objective lens of the present invention is applicable to an optical head device which serves as both of the CD and the BD, or an optical head device which serves as both of the DVD and the BD.

Furthermore, the objective lens of the present invention is not limited to the optical head device using two types of optical recording mediums having different thicknesses of transparent substrates, and the lens is also applicable to an optical head device using three or more types of optical recording mediums having different thicknesses of transparent substrates. In this case, in the objective lens, another peripheral region is concentrically formed on an outer peripheral side of a peripheral region in the above-described embodiment. The constitution of the present embodiment is applicable not only to the objective lens but also to a lens for another optical head device, such as a collimator lens.

### EXAMPLE

An example of an objective lens 3 will be described, to which the present invention is applied. Optical recording mediums in this example are a CD and a DVD.

Lens Design Data

Wavelengths λ1, λ2, numerical apertures NA1, NA2, and lens refractive indexes n1, n2 of the CD and the DVD, which are assumptions of lens design, are as follows.
CD
λ1=790 nm
NA1=0.47
n1=1.537
DVD
k2=660 nm
NA2=0.6
n2=1.540

Lens design data of the example will be described hereinafter. In the following data, a surface interval is an interval between an incidence surface and an emission surface in an optical axis. A stepped portion of the incidence surface corresponds to a distance from an intersection between the incidence surface and the optical axis to an inner peripheral end of each annular refraction surface. Furthermore, an aspherical shape Z(r) of each annular refraction surface is rotationally symmetric, and is represented by the following equation with respect to a radius coordinate r:

$$Z ( r ) = {cr}^{2} / [ 1 + {\{ 1 - ( 1 + k ) {c}^{2} {r}^{2} \}}^{1 / 2} ] + \\ {A}_{2} \cdot {r}^{2} + {A}_{4} \cdot {r}^{4} + {A}_{6} \cdot {r}^{6} + … ,$$

where c denotes an inverse number of a radius curvature R, k denotes a conical constant, and A₂

, A₄, A₆, . . . are secondary, quartic, sextic . . . aspherical coefficients. It is to be noted that in indications of the aspherical coefficients or the like, E and the subsequent number n means 1/10ⁿ. The data of the respective annular refraction surfaces are described in order from an innermost periphery toward an outer periphery.
Surface interval 1.75000
Incidence surface
Annular region=0 to 0.40000
Stepped portion=0.00000
R=1.94109
k=0.000000E+00
A₄=−0.893898E−02
Annular region=0.4 to 0.60000
Stepped portion=0.00864
R=1.94128
k=0.000000E+00
A₄=−0.676508E−02
Annular region=0.6 to 0.80000
Stepped portion=0.02474
R=1.93794
k=0.000000E+00
A4=−0.752818E−02
Annular region=0.8 to 0.95000
Stepped portion=0.02786
R=1.81480
k=0.452784E−01
A₄=−0.264601E−01
Annular region=0.95 to 1.35000
Stepped portion=0.01464
R=1.99361
k=0.413001E−01
A₄=0.238894E−02
A₆=−0.504509E−02
Annular region=1.35 to 1.43900
Stepped portion=0.04010
R=2.29433
k=0.479248E−03
A₄=0.191457E−01
A₆=−0.358908E−02
Annular region=1.439 to 1.83000
Stepped portion=0.03016
R=2.00971
k=−0.650893E+00
A₄=0.109546E−01
A₆=−0.575933E−03
Emission surface
R=−7.46182
k=0.23703E+01
A₄=0.255157E−01
A₆=−0.627395E−02
A₈=0.665314E−03
   Spherical Aberration Distribution

FIG. 7 shows a spherical aberration distribution at a time when the objective lens of the example is used. FIG. 7A and FIG. 7B are graphs showing the spherical aberration distributions with respect to a DVD and a CD, respectively

As shown in FIG. 7A, when the objective lens of the example is used, zero regions a1 and a12 exist where spherical aberration with respect to the DVD is zero in a range of R/3 to 2R/3 from an optical axis L (i.e., NA is in a range of 0.47/3 to 2×0.47/3). An increase/decrease region a 13 including a minimum value m2 also exists. Therefore, an effective value of the spherical aberration with respect to the DVD can be reduced to 0.01×λ2 or less. As a result, an effective value of a wave front aberration with respect to the DVD can be reduced to 0.04×λ2 or less.

Moreover, as shown in FIG. 7B, when the objective lens of the example is used, zero regions a14 and a15 exist where spherical aberration with respect to the CD is zero in a range of R/3 to 2R/3 from an optical axis L. An increase/decrease region a16 including a maximum value m3 also exists. Therefore, an effective value of the spherical aberration with respect to the CD can be reduced to 0.01×λ1 or less. As a result, an effective value of a wave front aberration with respect to the CD can be reduced to 0.04×λ1 or less.

When the objective lens of the example is used, the effective values of the spherical aberrations and the wave front aberrations of both of the CD and the DVD can be reduced and recording/reproducing functions with respect to both of the CD and the DVD can be enhanced.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An objective lens for an optical head device which condenses two or more laser beams having wavelengths adapted to two or more optical recording mediums having different thicknesses of transparent substrates on recording surfaces of the optical recording mediums via one optical condensing system to record information on the recording surfaces and/or reproduce the information on the recording surfaces, the objective lens comprising:
a refraction surface including: a middle region which is formed in a middle portion of the refraction surface centering on an optical axis of the objective lens and which is used with respect to all of the optical recording mediums; and a peripheral region which is concentrically formed adjacent to an outer peripheral side of the middle region, wherein assuming that a distance from the optical axis to an outer peripheral portion of the middle region in a direction crossing the optical axis at right angles is R, there exist, in a range of R/3 to 2R/3 from the optical axis, a zero region where spherical aberration with respect to at least one of the optical recording mediums is zero or an increase/decrease region where the spherical aberration with respect to at least one of the optical recording mediums increases or decreases toward zero.

2. The objective lens according to claim 1, wherein the middle region comprises a plurality of annular refraction surfaces having aspherical shapes which are mutually different in refractive force, and stepped portions are formed toward an optical axis direction in boundaries among the plurality of annular refraction surfaces.

3. The objective lens according to claim 1, wherein the optical recording mediums include a first optical recording medium on which a first laser beam having a first wavelength is condensed, and a second optical recording medium on which a second laser beam having a second wavelength shorter than the first wavelength is condensed, and the zero region or the increase/decrease region exists with respect to the second optical recording medium.

4. The objective lens according to claim 1, wherein the optical recording mediums include a first optical recording medium on which a first laser beam having a first wavelength is condensed, and a second optical recording medium on which a second laser beam having a second wavelength shorter than the first wavelength is condensed, and the zero region or the increase/decrease region exists with respect to the first optical recording medium.

5. An objective lens for an optical head device which condenses two or more laser beams having wavelengths adapted to two or more optical recording mediums having different thicknesses of transparent substrates on recording surfaces of the optical recording mediums via one optical condensing system to record information on the recording surfaces and/or reproduce the information on the recording surfaces, the objective lens comprising:
a refraction surface including: a middle region which is formed in a middle portion of the refraction surface centering on an optical axis of the objective lens and which is used with respect to all of the optical recording mediums; and a peripheral region which is concentrically formed adjacent to an outer peripheral side of the middle region,
wherein an optimum region where spherical aberration with respect to one optical recording medium is corrected to be optimum exists in at least one position in a range from the optical axis to an outer peripheral portion of the middle region in a direction crossing the optical axis at right angles.

6. The objective lens according to claim 5, wherein assuming that a distance from the optical axis to the outer peripheral portion of the middle region in the direction crossing the optical axis at right angles is R, the optimum region exists in a range of R/3 to 2R/3 from the optical axis.

7. An optical head device comprising: an optical condensing system having the objective lens according to claim 1; and a laser light source which emits the laser beams, wherein information is recorded on the recording surface and/or information on the recording surface is reproduced.

8. An objective lens for an optical head device which condenses two or more laser beams having wavelengths adapted to two or more optical recording mediums having different thicknesses of transparent substrates on recording surfaces of the optical recording mediums via one optical condensing system to record information on the recording surfaces and/or reproduce the information on the recording surfaces, the objective lens comprising:
a refraction surface including: a middle region which is formed in a middle portion of the refraction surface centering on an optical axis of the objective lens and which is used with respect to all of the optical recording mediums; and a peripheral region which is concentrically formed adjacent to an outer peripheral side of the middle region, wherein assuming that a distance from the optical axis to an outer peripheral portion of the middle region in a direction crossing the optical axis at right angles is R, there exist, in a range of R/3 to 2R/3 from the optical axis, a zero region where spherical aberration with respect to at least one of the optical recording mediums is zero and an increase/decrease region where the spherical aberration with respect to at least one of the optical recording mediums increases or decreases toward zero.

9. The objective lens according to claim 8, wherein the middle region comprises a plurality of annular refraction surfaces having aspherical shapes which are mutually different in refractive force, and stepped portions are formed toward an optical axis direction in boundaries among the plurality of annular refraction surfaces.

10. The objective lens according to claim 8, wherein the optical recording mediums include a first optical recording medium on which a first laser beam having a first wavelength is condensed, and a second optical recording medium on which a second laser beam having a second wavelength shorter than the first wavelength is condensed, and
the zero region and the increase/decrease region exist with respect to the second optical recording medium.

11. The objective lens according to claim 8, wherein the optical recording mediums include a first optical recording medium on which a first laser beam having a first wavelength is condensed, and a second optical recording medium on which a second laser beam having a second wavelength shorter than the first wavelength is condensed, and
the zero region and the increase/decrease region exist with respect to the first optical recording medium.

12. An optical head device comprising: an optical condensing system having the objective lens according to claim 8; and a laser light source which emits the laser beams, wherein information is recorded on the recording surface and/or information on the recording surface is reproduced.
